(19) United States
(12) Patent Application Publication
(10) Pub. No.: US 2008/0011499 A1
(43) Pub. Date: Jan. 17, 2008

(54) Hand-Held Tool Comprising a Shaft and a Lifting Control Bearing Which is Mounted on the Shaft

(76) Inventors: Dietmar Saur, Gomarigen (DE); Helmut Heinzelmann, Stuttgart (DE)

Correspondence Address: MICHAEL J. STRIKER, 103 EAST NECK ROAD, HUNTINGTON, NY, 11743, US

(21) Appl. No.: 11/720,126

(22) PCT Filed: Aug. 29, 2006
(86) PCT No.: PCT/EP06/65767

§ 371 Date: May 24, 2007

(30) Foreign Application Priority Data
Oct. 5, 2005 (DE) 10 2005 047 600.7

(51) Int. Cl. B25D 11/00

(52) U.S. Cl. 173/109

(57) ABSTRACT

The invention relates to a hand-held tool, in particular a hammer drill (10a, 10b), comprising a shaft (12) and a lifting control bearing (14a, 14b) which is mounted on the shaft (12a, 12b) and which is used to translate a rotational movement into a lifting movement. According to the invention, a percussion drive connection is arranged between the shaft (12) and the lifting control bearing (14) in at least one of the first switch configurations and the percussion drive connection is interrupted in at least one of the second switch configurations. The hand-held machine comprises a maintaining agent (16a, 16b) which fixes the lifting control bearing (14) to the second switch configuration.

### PRIOR ART

The invention is based on a hand-held tool having a shaft and having a lifting bearing, supported on the shaft, as generically defined by the preamble to claim 1.

A hand-held tool, in particular a drill hammer, having a shaft and having a lifting bearing, supported on the shaft, for converting a rotary motion of the shaft into a reciprocating motion is known. A gear of the hand-held tool, which gear includes the lifting bearing and the shaft, is shiftable. In particular, a rotary drive of a tool chuck and a percussion drive of a percussion mechanism can be switched on and off. For switching the aforementioned functions on and off, the shaft can be displaced into a plurality of switching configurations. In a first switching configuration, a percussion drive connection that is fixed against relative rotation exists between the shaft and the lifting bearing, so that the percussion drive is switched on. In a second switching configuration, the percussion drive connection is interrupted, so that the percussion mechanism is deactivated. Further switching configurations pertain to the switching on and off of the rotary drive and a variolock function.

### ADVANTAGES OF THE INVENTION

The invention is based on a hand-held tool, in particular a drill hammer, having a shaft and having a lifting bearing, supported on the shaft, for converting a rotary motion into a reciprocating motion, in which in at least a first switching configuration the percussion drive connection is interrupted and in at least a second switching configuration a percussion drive connection, which is fixed against relative rotation, exists between the shaft and the lifting bearing.

It is proposed that the hand-held tool include a retention means, which fixes the lifting bearing in the first switching configuration. As a result, the lifting bearing, despite the interrupted percussion drive connection, can be prevented from generating a reciprocating motion as a result of friction of the bearing of the lifting bearing on the shaft. By the avoidance of the unwanted reciprocating motions, a hand-held tool with improved running smoothness can be achieved, since no vibration that impairs the comfort of using the hand-held tool can be generated by the reciprocating motions.

The provisions of the invention can be employed especially advantageously in drill hammers, but in principle it would also be conceivable to use them in other hand-held tools that have a reciprocating or percussion drive that can be switched on and off. The term “fixation” refers in this connection to a reference system of a housing of the hand-held tool. The shaft on which the lifting bearing is supported is, in most hand-held tools of this generic type, a short intermediate shaft. In principle, however, the lifting bearing could be supported on a drive shaft or motor shaft. The invention is especially advantageously usable for fixation or braking of lifting bearings embodied as wobble bearings. In principle, however, its use in conjunction with eccentric bearings or deep-groove bearings would also be conceivable.

In a refinement of the invention, it is proposed that the retention means is located on a switch element for axial displacement of the shaft. As a result, an axial motion of the switch element that is to be performed anyway during a shifting operation can be used to make a connection that fixes the lifting bearing.

A lifting bearing that rotates at high speed can be braked by friction on the lifting bearing when the connection is made, if the switch element in the first switching configuration has an at least friction-locking rotary connection with the lifting bearing. The friction lock can be supplemented, after the braking of the lifting bearing, by a form lock or can fix the lifting bearing on its own.

The aforementioned advantages can, however, be realized independently of the switch element whenever the hand-held tool includes a friction lining for making a friction-locking rotary connection between the lifting bearing and the retention means. The friction lining can be embodied especially effectively and economically by a rubber ring.

A secure hold for fixation of the lifting bearing can be attained if the lifting bearing has a detent profile on one edge. The term “edge” is intended in this connection to mean an end region in an axial direction.

If the hand-held tool includes a form-locking element for form-locking connection of the lifting bearing to the switch element in a circumferential direction relative to the shaft, then in a simple way, a connection fixed against relative rotation can be made between the lifting bearing and the switch element. The form-locking element can be located either on the lifting bearing or on the switch element and is advantageously supplemented by a corresponding form-locking element on the respective other component. The form-locking element advantageously has a multidigital point symmetry, for instance a hexagonal or octagonal symmetry, so that a connection can be made in a plurality of rotary positions.

A shifting motion of the switch element can be used to fix the lifting bearing, if the form-locking element is provided for engaging a corresponding form-locking element in a switching motion direction of the switch element.

Convenient release of a tooth-on-tooth position of the retention means can be attained if the hand-held tool includes a synchronizing means for synchronizing the lifting bearing with the retention means. The synchronizing means may for instance be embodied as a synchronizing spring or as a synchronizing ring.

If the percussion drive connection is intended for driving a pneumatic percussion mechanism, then unwanted reciprocating motions of the percussion mechanism in the shut-off state can be avoided, and running smoothness of the hand-held tool can be improved in an especially lasting way. Moreover, additional noise production from unwanted, comparatively slight impacting of the beater on the percussion bolt can be avoided.

### DRAWINGS

Further advantages will become apparent from the ensuing description of the drawings. In the drawings, exemplary embodiments of the invention are shown. The drawings, description and claims include numerous characteristics in combination. One skilled in the art will expediently consider these characteristics individually as well as put them together to make useful further combinations.

Shown are:

FIG. 1, a drill hammer, having a shaft and a lifting bearing supported on the shaft;

FIG. 2, a gear of the drill hammer with the shaft of FIG. 1;

FIG. 3, the lifting bearing and the shaft of FIG. 1 as well as a switch element in a percussion drilling configuration;

FIG. 4, the lifting bearing, shaft and switch element in a rotary drilling configuration;

FIG. 5, the switch element and the shaft of FIGS. 1-4 without the lifting bearing;

FIG. 6, the lifting bearing from FIGS. 1-5;

FIG. 7, a switch element with a retention means in an alternative embodiment of the invention; and

FIG. 8, a lifting bearing corresponding to the switch element of FIG. 7.

### DESCRIPTION OF THE EXEMPLARY EMBODIMENTS

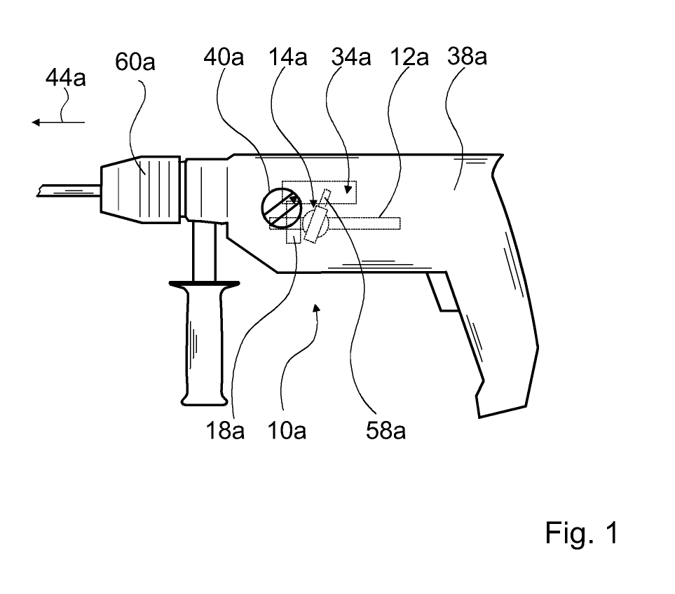

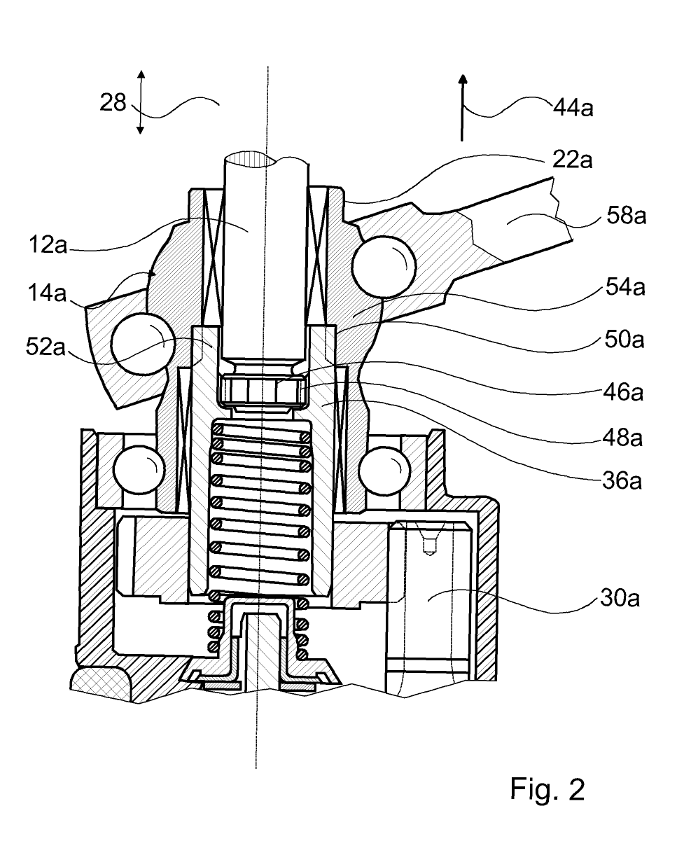

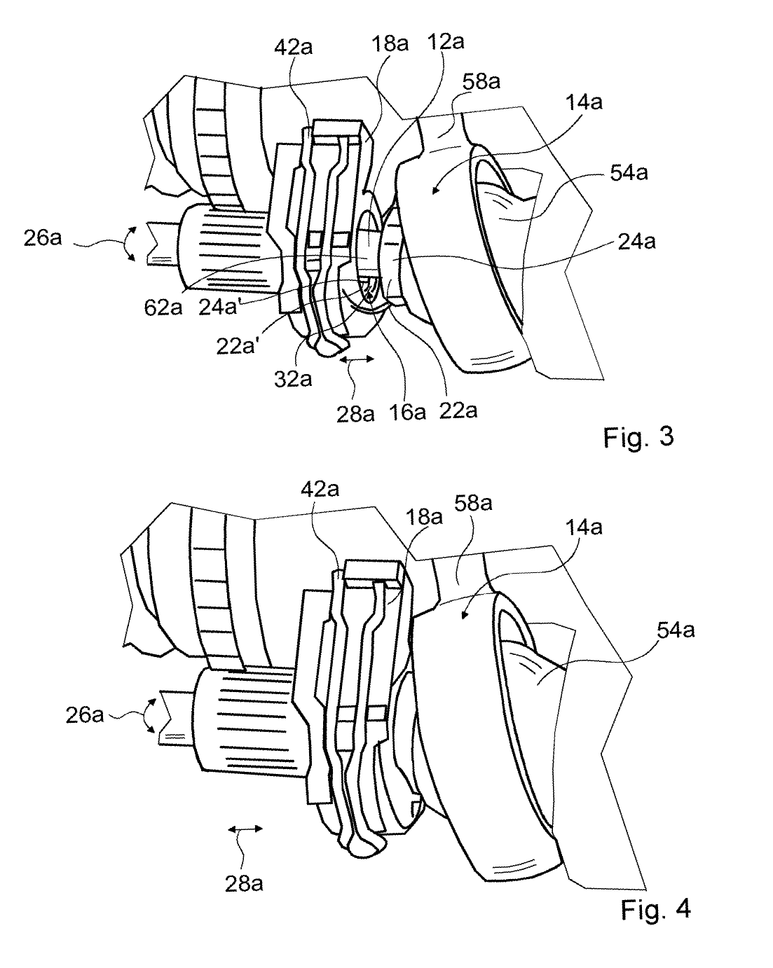

FIG. 1 shows a hand-held tool, embodied as a drill hammer 10a, with a shaft 12a, shown here only schematically, that as an intermediate shaft connects a drive shaft 30a (FIG. 2) to a lifting bearing 14a, supported on the shaft 12a and embodied as a wobble bearing, and to a rotary drive of a tool chuck 60a. For shifting the drill hammer 10a back and forth between various operating modes, the shaft 12a may be axially displaced via a shift knob 40a, supported on a housing 38a, and via a switch element 18a. For displacing the shaft 12a, an eccentric pin engages a leg spring 42a (FIGS. 3-4) of the switch element 18a.

In a first switching configuration, the shaft 12a is maximally displaced in one working direction 44a. At that time, a set of teeth 46a of the shaft 12a is not in engagement with a corresponding set of teeth 48a of an intermediate sleeve 36a, so that a rotary drive connection between the drive shaft 30a and the shaft 12a is interrupted. A percussion drive connection between the drive shaft 30a and the lifting bearing 14a is generated by the engagement of a set of external teeth 50a of the intermediate sleeve 36a; this sleeve is movable axially counter to the force of a spring, with a corresponding set of internal teeth 52a of the lifting bearing 14a. Therefore in the first switching configuration, only a percussion mechanism 34a, but not the rotary drive of the drill hammer 10a, is switched on, and so the drill hammer 10a can be operated in a chiseling mode.

In a middle switching configuration, the shaft 12a is in a middle position, which is shown in FIG. 2. The set of teeth 46a of the shaft 12a is then in engagement with the corresponding set of teeth 48a of the intermediate sleeve 36a, so that the rotary drive connection exists between the drive shaft 30a and the shaft 12a. The percussion drive connection between the drive shaft 30a and the lifting bearing 14a still exists. Therefore in the middle switching configuration, both the percussion mechanism 34a and the rotary drive of the drill hammer 10a are switched on, and thus the drill hammer 10a can be operated in a percussion drilling mode.

In the middle switching configuration, the intermediate sleeve 36a generates a percussion drive connection, which is fixed against relative rotation, between the shaft 12a and the lifting bearing 14a.

In a second switching configuration, the shaft 12a is maximally displaced counter to the working direction 44a. With the shaft 12a, the intermediate shaft 36a is also axially displaced counter to the working direction 44a counter to the force of the spring, so that the set of teeth 46a of the shaft 12a is then in engagement with the corresponding set of teeth 48a of the intermediate sleeve 36a. The rotary drive connection thus exists between the drive shaft 30a and the shaft 12a. The percussion drive connection between the drive shaft 30a and the lifting bearing 14a is interrupted, since as a result of the displacement of the intermediate sleeve 36a, there is no longer engagement of the external set of teeth 50a with the corresponding internal set of teeth 52a of the lifting bearing 14a. In the second switching configuration, therefore only the rotary drive of the drill hammer 10a is switched on, and thus the drill hammer 10a can be operated in a rotary drilling mode.

The lifting bearing 14a includes a drive bearing 54a, through which the shaft 12a reaches and which has an annular groove whose axis of symmetry is inclined relative to an axis of rotation. A ring with a lever extension 58a is supported in the groove, via balls, and because of the inclination of the axis of symmetry relative to the axis of rotation it executes alternating pivoting motions upon rotation of the drive bearing 54a. The lever extension 58a engages a piston, not explicitly shown here, of the percussion mechanism 34a of the drill hammer 10a. The percussion drive connection is therefore intended for driving a pneumatic percussion mechanism 34a.

The switch element 18a is connected axially firmly and rotatably to the shaft 12a for the displacement of the shaft 12a. In the first switching configuration and in the middle switching configuration (FIG. 3), a gap 62a exists between the drive bearing 54a of the lifting bearing 14a and the switch element 18a; this gap disappears in the second switching configuration, or when the percussion is switched off.

On one edge, toward the switch element 18a, of the drive bearing 54a of the lifting bearing 14a, an octagonal detent profile 22a is formed on integrally; it forms a form-locking element 24a for form-locking connection of the lifting bearing 14a to the switch element 18a in a circumferential direction 26a relative to the shaft 12a (see FIG. 6).

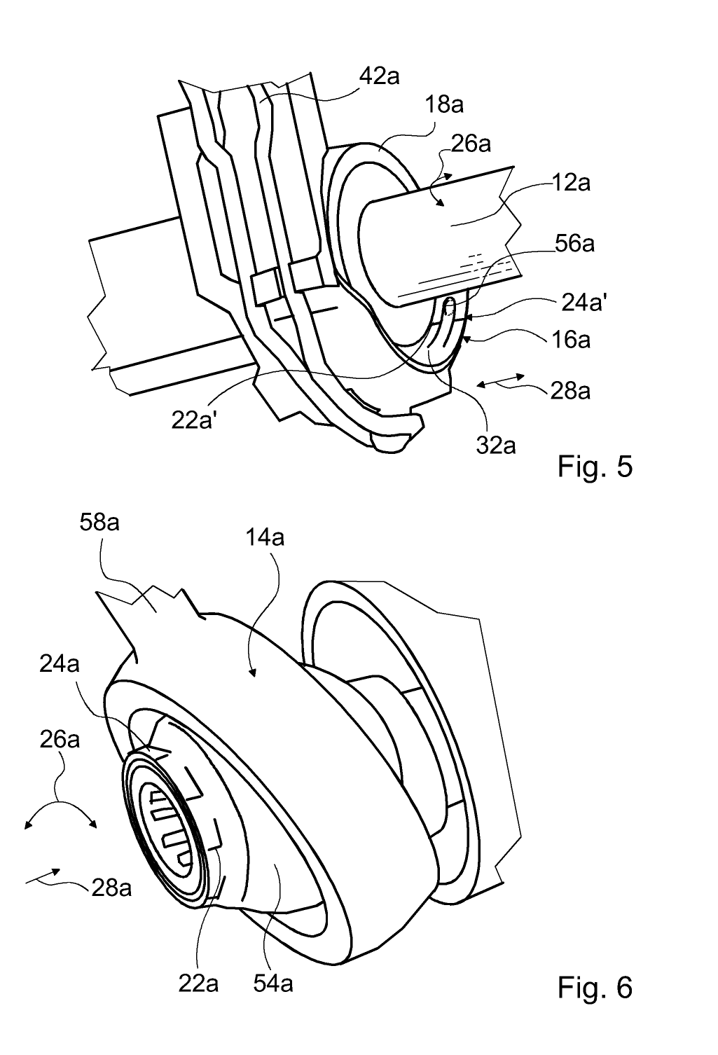

The form-locking element 24a is intended for engaging a corresponding form-locking element 24a′ or retention means 16a on the switch element 18a, counter to a switching motion direction 28a. The retention means 16a serves to fix the lifting bearing 14a in the second switching configuration, in which the percussion drive connection between the lifting bearing 14a and the drive shaft 30a is interrupted. The retention means 16a includes, besides a detent profile 22a′, a synchronizing means 32a, embodied as a spring arm that can be deflected in an axial direction or in the working direction 44a, for synchronizing the lifting bearing 14a with the retention means 16a (FIG. 5).

A radially inward-protruding cam 56a is formed integrally onto the synchronizing means 32a. If upon displacement of the switch element 18a, in a shifting motion from the middle switching configuration to the second switching configuration, the cam 56 comes into contact with a corner of the detent profile 22a, then the synchronizing means 32a is deflected counter to the switching motion direction 28a. A radius of the detent profile 22a, in the middle of its edge is shorter than a radius of the position of the cam 56a, so that after a brief rotation of the drive bearing 54a, the synchronizing means 32a snaps over the edge of the detent profile 22a, and by means of the cam 56a, a form lock is created between the lifting bearing 14a and the switch element 18a (FIG. 4).

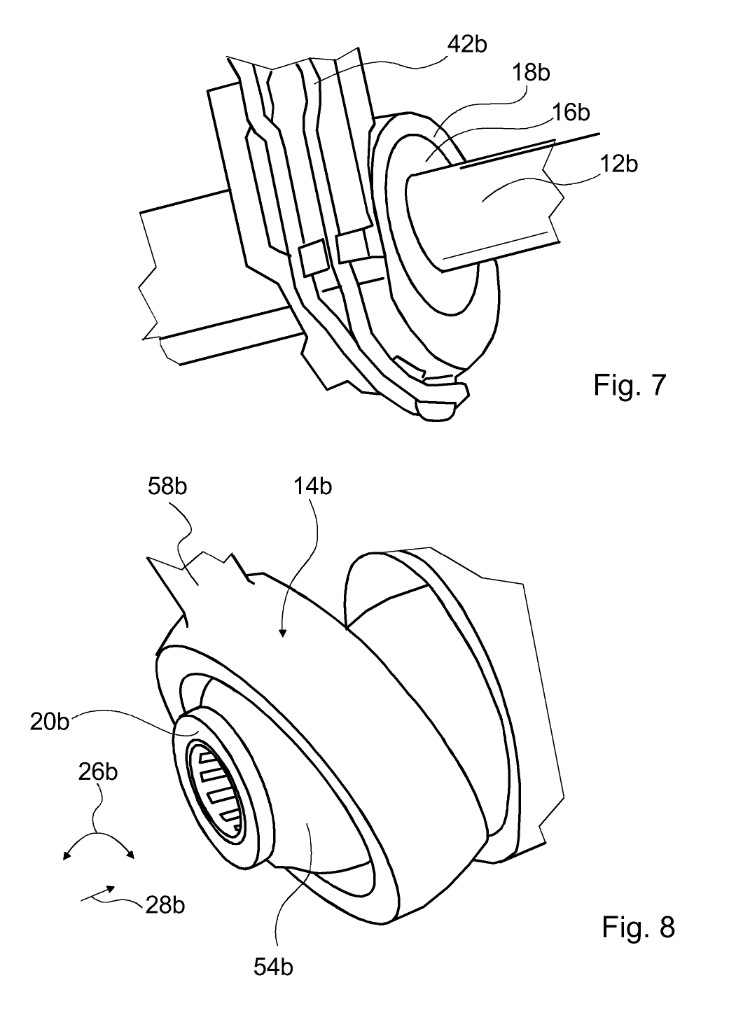

FIGS. 7 and 8 show a further embodiment of the invention. The description will be limited essentially to differences from the exemplary embodiment shown in FIGS. 1-6, to which reference should be made for characteristics that remain the same. Analogous characteristics are identified by the same reference numerals, with the letters “a” and “b” being added to distinguish the exemplary embodiments.

A retention means 16b shown in FIG. 7 is embodied as a flat friction face, which forms a face end, toward a lifting bearing 14b, of the switch element 18b. A friction lining 20b, embodied as a pressed-on rubber ring, is located on a front edge of a drive bearing 54b of the lifting bearing 14b and comes into contact with the retention means 16b in the second switching configuration.

The switch element 18b therefore, in the second switching configuration, has a friction-locking rotary connection with the lifting bearing 14b. If the operating mode of a drill hammer 10b, including the switch element 18b, is shifted during operation of the drill hammer 10b, then the retention means 16b brakes the rotating lifting bearing 14b as soon as the friction lining 20b comes into contact with the retention means 16b. A synchronizing means and a form-locking element can advantageously be dispensed with, in the embodiment of the invention shown in FIGS. 7 and 8. A contact pressure of the retention means 16b on the friction lining 20b is so great that a frictional force of the friction lock overcompensates for any moment created by bearing friction.

1. A hand-held tool, in particular a drill hammer (10), having a shaft (12) and having a lifting bearing (14), supported on the shaft (12), for converting a rotary motion into a reciprocating motion, in which in at least a first switching configuration, a percussion drive connection exists between the shaft (12) and the lifting bearing (14), and in at least a second switching configuration, the percussion drive connection is interrupted, characterized by a retention means (16), which fixes the lifting bearing (14) in the second switching configuration.

2. The hand-held tool as defined by claim 1, characterized in that the retention means (16) is located on a switch element (18) for axial displacement of the shaft (12).

3. The hand-held tool as defined by claim 2, characterized in that the switch element (18) in the second switching configuration has an at least friction-locking rotary connection with the lifting bearing (14).

4. The hand-held tool as defined by claim 1, characterized by a friction lining (20) for making a friction-locking rotary connection between the lifting bearing (14) and the retention means (16).

5. The hand-held tool as defined by claim 1, characterized by a detent profile (22a) on one edge of the lifting bearing (14a).

6. The hand-held tool as defined by claim 2, characterized by a form-locking element (24a) for form-locking connection of the lifting bearing (14a) to the switch element (18a) in a circumferential direction (26a) relative to the shaft (12a).

7. The hand-held tool as defined by claim 6, characterized in that the form-locking element (24a) is provided for engaging a corresponding form-locking element (24a′) in a switching motion direction (28a) of the switch element (18a).

8. The hand-held tool as defined by claim 5, characterized by a synchronizing means (32a) for synchronizing the lifting bearing (14a) with the retention means (16a).

9. The hand-held tool as defined by claim 1, characterized in that the percussion drive connection is intended for driving a pneumatic percussion mechanism (34).
